(19) United States
(12) Patent Application Publication
(10) Pub. No.: US 2009/0315872 A1
(43) Pub. Date: Dec. 24, 2009

(54) LIQUID CRYSTAL DISPLAY APPARATUS AND LIQUID CRYSTAL PANEL DRIVING MEHTOD

(76) Inventors: Hiroaki Ikeda, Tokyo (JP); Reiichi Kobayashi, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/312,289

(22) PCT Filed: Nov. 29, 2007
(86) PCT No.: PCT/JP2007/073533

§ 371 Date: May 4, 2009

(30) Foreign Application Priority Data
Dec. 1, 2006 (JP) 2006-325999

(51) Int. Cl. G09G 3/36; G09G 5/00

(52) U.S. Cl. 345/209; 345/96

(57) ABSTRACT

A liquid crystal display apparatus includes common voltage generator circuit (5) for supplying a common voltage to a common electrode connected in common to a plurality of liquid crystal cells which form part of liquid crystal panel (9); liquid crystal driving circuit (2) for inversely driving liquid crystal panel (9); timer (8) for measuring a time for which liquid crystal panel 9 has been used; storage unit (10) for storing characteristic data which represents the relationship between used hours of liquid crystal panel (9) and an optimal value for the common voltage; and control unit (4) for determining a time for which liquid crystal panel (9) has been used up to the present time based on a measurement result by timer (8), retrieving an optimal value for the common voltage for the determined used time with reference to the characteristic data stored in storage unit (10), and controlling such that a magnitude of the common voltage output from the common voltage generator circuit is equal to the optimal value.

### TECHNICAL FIELD

The present invention relates to a liquid crystal display apparatus using a liquid crystal panel, represented by a liquid crystal projector, and more particularly, to a liquid crystal display apparatus which comprises a plurality of liquid crystal cells commonly connected to a common electrode which is supplied with a common voltage.

### BACKGROUND ART

In a liquid crystal display apparatus, local unevenness can occur in a display on a liquid crystal panel because it is difficult to completely match the voltage-transmissivity characteristic (hereinafter called the “V-T characteristic”) of each liquid crystal cell which forms part of the liquid crystal panel.

Also, when the liquid crystal cells are applied with a voltage of the same polarity at all times, impurities mixed in the liquid crystal cells are charged to cause a DC voltage to be generated due to a phenomenon called “polarization”, or result in polarization in liquid crystal molecules themselves as well, possibly leading to a significant degradation in display definition. Particularly, when the polarization occurs in the liquid crystal molecules themselves, the liquid crystal molecules still hold a state in which they have been placed, even after stopping the application of the voltage to the liquid crystal cells. Accordingly, for example, even if the liquid crystal cells are supplied with a voltage corresponding to a video signal to display an image and then the supply of the video signal is stopped, the liquid crystal cells still display the preceding image (afterimage). This phenomenon is called a “burn-in” phenomenon for convenience. In this regard, liquid crystal cells which suffer from the burn-in, unlike a burnt-in CRT (Cathode Ray Tube), are recovered by leaving them without particular treatments for a long time or by applying them with a voltage of opposite polarity.

For purposes of preventing the display unevenness, burn-in phenomenon, and deterioration of liquid crystal, a liquid crystal display apparatus is driven by an AC driving mode which involves inverting the polarity of a voltage applied to the liquid crystal at a predetermined period. The AC driving mode includes a dot inversion driving mode, a line inversion driving mode, a frame inversion driving mode and the like, and a liquid crystal panel is driven by one of these modes or a combination of plural modes in a liquid crystal display apparatus.

Generally, a normally white liquid crystal panel is employed in a liquid crystal projector which attaches importance to the brightness. In the normally white liquid crystal panel, a “white” display represents a state in which no voltage is applied, and approaches a “black” display as video data has a larger amplitude. On the other hand, a normally black liquid crystal display panel presents display operations reverse to the foregoing. These normally white liquid crystal panel and normally black liquid crystal panel can be basically made up of the same circuits.

In the following, a specific description will be given of a line inversion/frame inversion driving mode in a normally white liquid crystal panel. In the following description, assume that “video data” refers to that which has reversed white and black for use with normally white liquid crystal, a “video signal” refers to a signal of the positive polarity. In this regard, techniques in the following description on the normally white liquid crystal panel can be applied to a normally black liquid crystal panel.

FIG. 1 shows the waveform of a video data for the line inversion/frame inversion driving mode. In the video data shown in FIG. 1, video data of the positive polarity and video data of the negative polarity, the polarity of which is inverted with reference to reference voltage Vref, are alternately switched every horizontal scanning period. The video data of the positive polarity and the video data of the negative polarity are vertically symmetric about reference voltage Vref. Common voltage Vcom is a voltage applied to a common electrode of each liquid crystal cell, and is adjusted to minimize flicker (flickering in brightness) caused by the video data which inverts. Such an adjustment of common voltage Vcom is described in JP-2004-020657A and JP-2000-267618A.

FIG. 2 shows an equivalent circuit of a liquid crystal cell in a liquid crystal panel which is driven in the AC driving mode. A TFT is provided in a region in which video signal line L1 intersects with gate line L2. CLC designates the capacitance of the liquid crystal cell; CS an additional capacitance; and CGD a parasitic capacitance between the gate and drain of the TFT, respectively. When a voltage is applied to an intended liquid crystal cell (i.e., when a video signal is written), gate line L2 goes High, causing the TFT to enter a conductive state. After the video signal has been written, gate line L2 goes Low, after which the written video signal is held. When gate line L2 changes from High to Low, liquid crystal cell potential VLC becomes lower due to a differentiating effect of parasitic capacitance CGD. This voltage drop is constant irrespective of the polarity of the video signal. Also, common voltage Vcom reaches an optimally adjusted value at a voltage lower than reference voltage Vref which is the central value of the video data, due to the influence of a voltage drop caused by a composite capacitance of liquid crystal cell capacitance CLC and additional capacitance CS.

Nematic liquid crystal used in liquid crystal display apparatuses generally has a rod-like shape, and has a dielectric anisotropy which means that the dielectric constant in the major axis direction is larger than the dielectric constant in the minor axis direction. FIGS. 3A to 3C schematically show the state of a liquid crystal molecule in accordance with applied voltages.

FIG. 3A is a state in which video data is “white,” i.e., a state in which no electric field is applied between a TFT substrate and an opposing substrate. The liquid crystal molecule is aligned on an alignment film, and disposed with one head slightly lifting up. This state of the liquid crystal molecule is called “pre-tilt,” and the liquid crystal molecule always rotates in a fixed direction when a voltage is applied. In this example, the application of a voltage causes the liquid crystal molecule to always rotate in a counter-clockwise direction.

FIG. 3B represents the state of the liquid crystal molecule when it is applied with video data at a signal level of 50%, by way of example. An electric field corresponding to the video data is applied between the TFT substrate and opposing substrate, where the liquid crystal molecule is obliquely rising up in the counter-clockwise direction. This is because the dielectric constant in the major axis direction is larger than the dielectric constant in the minor axis direction.

FIG. 3C is a state in which video data is “black,” i.e., a state in which a maximum electric field is applied between the TFT substrate and the opposing substrate. Since the liquid crystal molecule is completely rising up, light is blocked.

As shown in FIGS. 3A to 3C, when no voltage is applied, the liquid crystal molecule is disposed substantially in the horizontal state, and gradually rises up in accordance with the magnitude of the applied voltage. In this way, the dielectric constant differs depending on the magnitude of the applied voltage. A change in the dielectric constant results in a change in electrostatic capacitance. The potential of a liquid crystal cell is affected by a composite capacitance of a stray capacitance between the gate and drain of the TFT, liquid crystal capacitance, and additional capacitance, whereas the common voltage is adjusted by a voltage which is lower than the liquid crystal cell potential by a voltage drop of the latter. Then, the voltage drop of the latter varies in accordance with a voltage applied to the liquid crystal cell (video data).

FIG. 4 shows a liquid crystal display apparatus which employs a line inversion/frame inversion driving mode. Referring to FIG. 4, the liquid crystal display apparatus comprises video signal processing circuit 100, liquid crystal driving circuit 101, common voltage generator circuit 102, and liquid crystal panel 103.

Liquid crystal panel 103 is a liquid crystal panel, for example, in the structure shown in FIG. 2. Video signal processing circuit 100 performs processing for converting a video signal supplied from input terminal IN to a signal suitable for display on liquid crystal panel 103, for example, scaling processing, frequency conversion processing and the like. The scaling processing is processing for converting the resolution of an input video signal to an appropriate resolution when the resolution of the input video signal in a displayed image is different from the resolution of liquid crystal panel 103. The frequency conversion processing is processing for converting the frequency of the input video signal to an appropriate frequency when the frequency of the input video signal is different from the driving frequency of the liquid crystal panel.

Liquid crystal driving circuit 101 performs V-T correction processing for correcting the voltage (V)-transmissivity (T) characteristic of liquid crystal panel 103, represented by a sigmoidal line, to a linear characteristic (in which V changes in proportion to T), AC drive processing for performing line inversion/frame inversion processing on a V-T corrected video signal. Also, liquid crystal driving circuit 101 includes a circuit for generating a variety of timing signals for driving liquid crystal panel 103. The timing signals includes timing signal Vd for inverting the polarity of a voltage supplied to each liquid crystal cell of liquid crystal panel 103.

Common voltage generator circuit 102 generates common voltage Vcom which is applied to a common electrode of each liquid crystal cell in liquid crystal panel 103. The magnitude of common voltage Vcom has been previously adjusted to minimize flicker which is caused by the inversion of the video data. A method of adjusting common voltage Vcom may involve synchronizing a measuring device with timing signal Vd, measuring the brightness of a displayed image related to the video data (frame) of the positive polarity, and the brightness of a displayed image related to the video data (frame) of the negative polarity, respectively, using the measuring device, and adjusting common voltage Vcom so as to minimize the difference between them. Alternatively, common voltage Vcom may be adjusted by preparing a signal which represents solid white at the positive polarity and solid black at the negative polarity, and a signal which represents solid black at the positive polarity and solid white at the negative polarity, and minimizing the brightness of images displayed by both the signals. Alternatively, common voltage Vcom may be visually adjusted without using the measuring device so as to provide a good display image.

However, in the display apparatus which involves the inversion driving as described above, a shift in the adjusted value of the common voltage from an optimal value causes polarization of liquid crystal molecules and impurities, resulting in a problem of burn-in. In the following, the problem will be described in a specific manner.

In the adjustment of the common voltage, the common voltage is adjusted to an optimal value visually or by utilizing a measuring device so as to provide a good projected image. FIG. 5 is a graph which represents the relationship between a video signal level and the optimal value for the common voltage. The vertical axis indicates the optimal voltage value for the common voltage, while the horizontal axis indicates the video signal level. Generally, the common voltage is adjusted in a stage in which a video signal is supplied at the signal level of 50%. The reason for that is that the V-T characteristic (characteristic representing the relationship between the voltage and transmissivity) of liquid crystal presents a sigmoidal non-linear characteristic which exhibits a sudden change in transmissivity upon application of a voltage at about 50%, so that the common voltage easily adjusted.

As shown in FIG. 5, the optimal value for the common voltage exponentially changes with respect to the video signal level. Accordingly, when a still image is displayed at a low average video signal level (APL) with the common voltage adjusted at the video signal level in the vicinity of 50%, the adjusted value of the common voltage will deviate from the optimal common voltage value at the signal level of the still image. The difference between the adjusted value and optimal value for the common voltage depends on the magnitude of changes in the optimal value (APL dependence) in the graph shown in FIG. 5, and liquid crystal molecules and impurities undergo the polarization when this difference is large to some degree. Therefore, if the still image with low APL is continuously displayed for a long period, the liquid crystal molecules and impurities undergo the polarization due to the difference between the adjusted value and optimal value for the common voltage, resulting in the burn-in. A burn-in phenomenon similar to this occurs as well when a still image with high APL is displayed for a long period. However, when the still image with high APL is displayed, the burn-in is less likely to occur because the difference between the adjusted value and optimal value for the common voltage is smaller than that when the still image with low APL is displayed.

The foregoing burn-in problem can be solved by adjusting the common voltage value in accordance with the APL of an input video signal. JP-2000-267618A describes an apparatus which can adjust a common voltage in accordance with APL of an input video signal.

### DISCLOSURE OF THE INVENTION

However, the liquid crystal display apparatus described above suffers from a problem of the following burn-in separate from the burn-in problem associated with the APL dependence.

Depending on conditions such as the materials of the liquid crystal which forms part of a liquid crystal panel, alignment films and the like, the optimal value for the common voltage can vary together with aging changes. Variations in the optimal value for the common voltage due to the aging change can extend from several tens of hours to several hundred hours. FIG. 6 shows variations in the optimal value for the common voltage associated with aging changes at a video signal level of 50%. The vertical axis indicates the optimal value for common voltage Vcom, while the horizontal axis indicates the elapsed time. In this way, the optimal value for the common voltage gradually increases together with aging changes, so that even if the common voltage is adjusted to an optimal value upon shipment of the product, the adjusted value gradually deviates from the optimal value over time, resulting in the polarization of liquid crystal molecules and impurities to cause the burn-in.

Like the aging changes, the adjusted value of the common voltage deviates from the optimal value due to fluctuations in temperature of the liquid crystal panel, resulting in the polarization of liquid crystal molecules and impurities to cause the burn-in.

It is an exemplary purpose of the present invention to solve the problems mentioned above and to provide a liquid crystal display apparatus which is capable of restraining burn-in due to polarization of liquid crystal molecules and impurities caused by variations in an optimal value for a common voltage associated with aging changes or changes in environmental temperature.

To achieve the above purpose, a liquid crystal display apparatus according to a first exemplary aspect of the invention is a liquid crystal display apparatus including a liquid crystal panel, which is characterized by including a common voltage generator circuit for supplying a common voltage to a common electrode connected in common to a plurality of liquid crystal cells which form part of the liquid crystal panel, a liquid crystal driving circuit for conducting a control for supplying a voltage in accordance with a video signal input from the outside to the plurality of liquid crystal cells to display an image on the liquid crystal panel, and for inverting the polarity of the voltage supplied to the plurality of liquid crystal cells at a predetermined period, a timer for measuring a time for which the liquid crystal panel has been used, a storage unit for storing characteristic data which represents the relationship between a used time of the liquid crystal panel and an optimal value for the common voltage, and a control unit for determining a time for which the liquid crystal panel has been used up to the present time based on a measurement result by the timer, retrieving an optimal value for the common voltage at the used hours with reference to the characteristic data stored in the storage unit, and controlling such that the magnitude of the common voltage output from the common voltage generator circuit is equal to the optimal value.

According to the first exemplary aspect of the invention, the control unit retrieves an optimal value for the common voltage for a current used hours from the characteristic data which represents the relationship between the used hours of the liquid crystal panel and the optimal value for the common voltage, and controls the common voltage such that it is equal to the optimal value. With this control, the optimal value for the common voltage is corrected for a deviation associated with aging changes of the liquid crystal panel.

A liquid crystal display apparatus according to a second exemplary aspect of the invention is a liquid crystal display apparatus including a liquid crystal panel, which is characterized by including a common voltage generator circuit for supplying a common voltage to a common electrode connected in common to a plurality of liquid crystal cells which form part of the liquid crystal panel, a liquid crystal driving circuit for conducting a control for supplying a voltage in accordance with a video signal input from the outside to the plurality of liquid crystal cells to display an image on the liquid crystal panel, and for inverting the polarity of the voltage supplied to the plurality of liquid crystal cells at a predetermined period, an average signal level detector circuit for detecting an average signal level of the video signal, a timer for measuring a time for which the liquid crystal panel has been used, a lookup table for storing a plurality of characteristic data which represent the relationship between a signal level of the video signal and an optimal value for the common voltage, corresponding to used hours of the liquid crystal panel, and a control unit for determining a time for which the liquid crystal panel has been used up to the present time based on a measurement result by the timer, retrieving characteristic data corresponding to the used hours from the lookup table, calculating an optimal value for the common voltage based on the characteristic data and an average signal level detected in the average signal level detector circuit, and controlling such that the magnitude of the common voltage output from the common voltage generator circuit is equal to the optimal value.

According to the second exemplary aspect of the invention, the control unit controls the magnitude of the common voltage output from the common voltage generator circuit in accordance with an average video signal level (APL) value, so that when a still image with a low APL, for example, is displayed, an optimal common voltage value at the signal level of the still image is supplied from the common voltage generator circuit to the liquid crystal panel. Also, the control unit controls the magnitude of the common voltage in accordance with a time for which the liquid crystal panel has been used. With this control, the optimal value for the common voltage is corrected for a deviation associated with aging changes of the liquid crystal panel. In this way, since the common voltage is adjusted in accordance with a deviation of the optimal value for the common voltage associated with the APL dependence and aging changes, the polarization of liquid crystal molecules and impurities is restrained.

A liquid crystal display apparatus according to a third exemplary aspect of the invention is a liquid crystal display apparatus including a liquid crystal panel, which is characterized by including a common voltage generator circuit for supplying a common voltage to a common electrode connected in common to a plurality of liquid crystal cells which form part of the liquid crystal panel, a liquid crystal driving circuit for conducting a control for supplying a voltage in accordance with a video signal input from the outside to the plurality of liquid crystal cells to display an image on the liquid crystal panel, and for inverting the polarity of the voltage supplied to the plurality of liquid crystal cells at a predetermined period, an average signal level detector circuit for detecting an average signal level of the video signal, a timer for measuring a time for which the liquid crystal panel has been used, a lookup table for storing characteristic data which represents the relationship between a signal level of the video signal and an optimal value for the common voltage, and a control unit for calculating an optimal value for the common voltage based on the characteristic data stored in the lookup table, and an average signal level detected by the average signal level detector circuit, and controlling such that the magnitude of the common voltage output from the common voltage generator circuit is equal to the optimal value, wherein the control unit determines a time for which the liquid crystal panel has been used up to the present time based on a measurement result by the timer, and corrects the optimal value calculated based on the characteristic data based on the used hours by an approximation equation which represents a deviation of the optimal value for the common voltage associated with aging changes of the liquid crystal panel.

In the liquid crystal display apparatus according to the third exemplary aspect of the invention, the common voltage is also adjusted in accordance with a deviation of the optimal value for the common voltage associated with the APL dependence and aging changes in a manner similar to the second invention, thus restraining the polarization of liquid crystal molecules and impurities.

A liquid crystal display apparatus according to a fourth exemplary aspect of the invention is a liquid crystal display apparatus including a liquid crystal panel, which is characterized by including a common voltage generator circuit for supplying a common voltage to a common electrode connected in common to a plurality of liquid crystal cells which form part of the liquid crystal panel, a liquid crystal driving circuit for conducting a control for supplying a voltage in accordance with a video signal input from the outside to the plurality of liquid crystal cells to display an image on the liquid crystal panel, and for inverting the polarity of the voltage supplied to the plurality of liquid crystal cells at a predetermined period, a temperature sensor for measuring the temperature of the liquid crystal panel, a storage unit for storing characteristic data which represents the relationship between the temperature of the liquid crystal panel and an optimal value for the common voltage, and a control unit for determining the temperature of the liquid crystal panel based on a measurement result by the temperature sensor, retrieving an optimal value for the common voltage for the temperature with reference to the characteristic data stored in the storage unit, and controlling such that the magnitude of the common voltage output from the common voltage generator circuit is equal to the optimal value.

According to the fourth exemplary aspect of the invention, the control unit retrieves an optimal value for the common voltage at a current temperature from the characteristic data which represents the relationship between the temperature of the liquid crystal panel and the optimal value for the common voltage, and controls the common voltage such that it is equal to the optimal value. With this control, the optimal value for the common voltage is corrected for a deviation associated with a change in temperature of the liquid crystal panel.

A liquid crystal display apparatus according to a fifth exemplary aspect of the invention is a liquid crystal display apparatus including a liquid crystal panel, which is characterized by including a common voltage generator circuit for supplying a common voltage to a common electrode connected in common to a plurality of liquid crystal cells which form part of the liquid crystal panel, a liquid crystal driving circuit for conducting a control for supplying a voltage in accordance with a video signal input from the outside to the plurality of liquid crystal cells to display an image on the liquid crystal panel, and for inverting the polarity of the voltage supplied to the plurality of liquid crystal cells at a predetermined period, an average signal level detector circuit for detecting an average signal level of the video signal, a temperature sensor for measuring the temperature of the liquid crystal panel, a lookup table for storing characteristic data which represents the relationship between a signal level of the video signal and an optimal value for the common voltage for each of a reference to the characteristic data temperature of the liquid crystal panel, and a control unit for determining a current temperature of the liquid crystal panel based on a measurement result by the temperature sensor, retrieving the characteristic data corresponding to the temperature from the lookup table, calculating an optimal value for the common voltage based on the characteristic data and an average signal level detected in the average signal level detector circuit, and controlling such that the magnitude of the common voltage output from the common voltage generator circuit is equal to the optimal value.

According to the fifth exemplary aspect of the invention, the control unit controls the magnitude of the common voltage output from the common voltage generator circuit in accordance with an average video signal level (APL) value. With this control, the optimal value for the common voltage is corrected for a deviation associated with the APL dependence. Also, the control unit controls the magnitude of the common voltage in accordance with a change in temperature of the liquid crystal panel. With this control, the optimal value for the common voltage is corrected for a deviation associated with a change in temperature of the liquid crystal panel. In this way, since the common voltage is adjusted in accordance with a deviation of the optimal value for the common voltage associated with the APL dependence and change in temperature, the polarization of liquid crystal molecules and impurities is restrained.

A liquid crystal display apparatus according to a sixth exemplary aspect of the invention is a liquid crystal display apparatus including a liquid crystal panel, which is characterized by including a common voltage generator circuit for supplying a common voltage to a common electrode connected in common to a plurality of liquid crystal cells which form part of the liquid crystal panel, a liquid crystal driving circuit for conducting a control for supplying a voltage in accordance with a video signal input from the outside to the plurality of liquid crystal cells to display an image on the liquid crystal panel, and for inverting the polarity of the voltage supplied to the plurality of liquid crystal cells at a predetermined period, an average signal level detector circuit for detecting an average signal level of the video signal, a timer for measuring a time for which the liquid crystal panel has been used, a lookup table for storing characteristic data which represents the relationship between a signal level of the video signal and an optimal value for the common voltage, and a control unit for calculating an optimal value for the common voltage based on the characteristic data stored in the lookup table, and an average signal level detected by the average signal level detector circuit, and controlling such that the magnitude of the common voltage output from the common voltage generator circuit is equal to the optimal value, wherein the control unit determines a current temperature of the liquid crystal panel based on a measurement result by the temperature sensor, and corrects the optimal value calculated based on the characteristic data based on the temperature by an approximation equation which represents a deviation of the optimal value for the common voltage associated with a change in temperature of the liquid crystal panel.

In the liquid crystal display apparatus according to the sixth exemplary aspect of the invention, the common voltage is also adjusted in accordance with a deviation of the optimal value for the common voltage associated with the APL dependence and change in temperature in a manner similar to the fifth invention, thus restraining the polarization of liquid crystal molecules and impurities.

As described above, according to the present invention, it is possible to provide a liquid crystal display apparatus which is less likely to suffer from the burn-in of the liquid crystal cells because the polarization of liquid crystal molecules and impurities associated with aging change and change in temperature of the liquid crystal panel is restrained.

The above and other exemplary purposes, features, and advantages of the present invention will become apparent from the following description with reference to the accompanying drawings which illustrate examples of the present invention.

### BRIEF DESCRIPTION OF THE DRAWINGS

FIG. 1 is a waveform chart showing the waveform of video data for a line inversion/frame inversion driving mode;

FIG. 2 is a circuit diagram showing an equivalent circuit of a liquid crystal cell in a liquid crystal panel which is driven in an AC driving mode;

FIG. 3A is a schematic diagram showing a state of a liquid crystal molecule in accordance with an applied voltage;

FIG. 3B is a schematic diagram showing the state of the liquid crystal molecule in accordance with an applied voltage;

FIG. 3C is a schematic diagram showing the state of a liquid crystal molecule in accordance with an applied voltage;

FIG. 4 is a block diagram showing a liquid crystal display apparatus which employs a line inversion/frame inversion driving mode;

FIG. 5 is a characteristic diagram showing a relationship between a video signal level and an optimal value for a common voltage;

FIG. 6 is a characteristic diagram showing a change in the optimal value for the common voltage associated with aging changes of a liquid crystal panel at a video signal level of 50%;

FIG. 7 is a block diagram generally showing the configuration of a liquid crystal display apparatus according to a first exemplary embodiment of the present invention;

FIG. 8 is a block diagram generally showing the configuration of a liquid crystal display apparatus according to a second exemplary embodiment of the present invention;

FIG. 9 is a block diagram generally showing the configuration of a liquid crystal display apparatus according to a third exemplary embodiment of the present invention;

FIG. 10 is a characteristic diagram showing an example of characteristic data stored in a lookup table;

FIG. 11 is a flow chart showing an example of a common voltage control procedure; and

FIG. 12 is a block diagram showing the configuration of a liquid crystal display apparatus according to a fourth exemplary embodiment of the present invention.

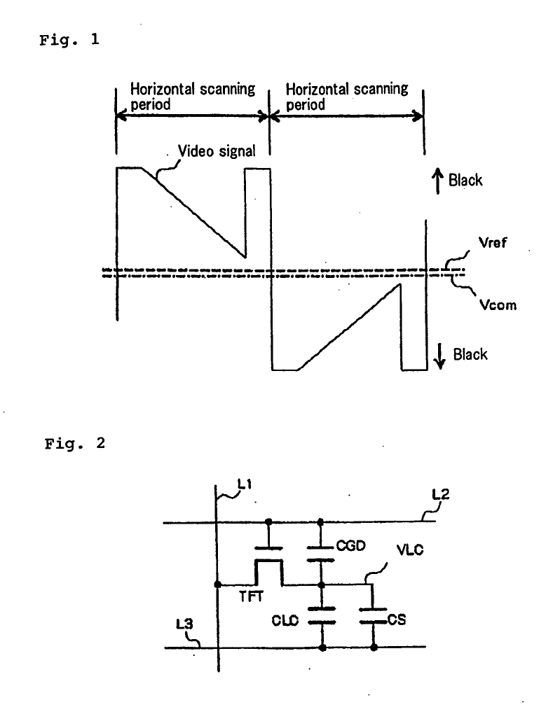

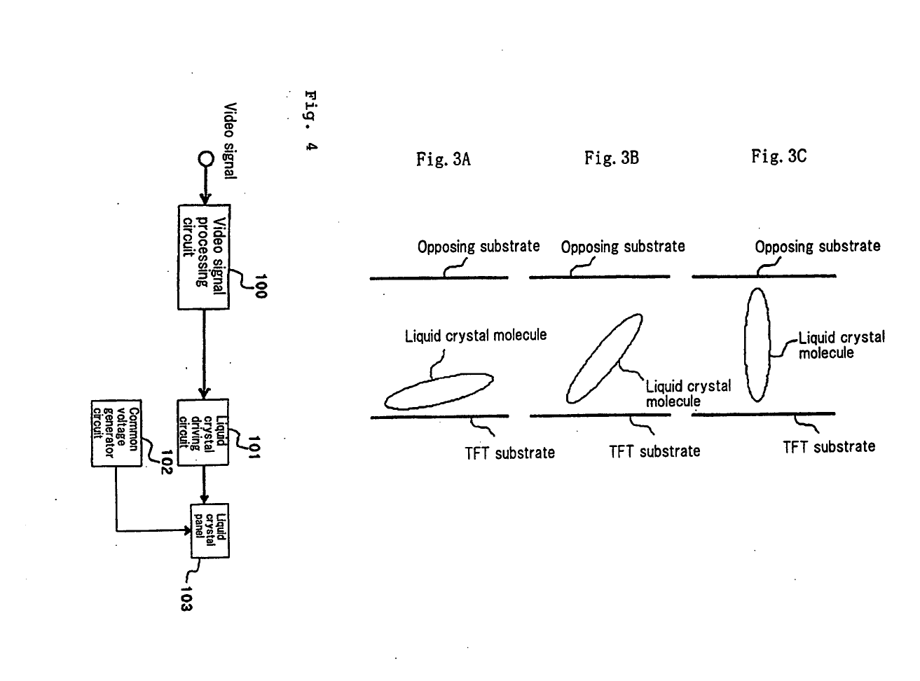

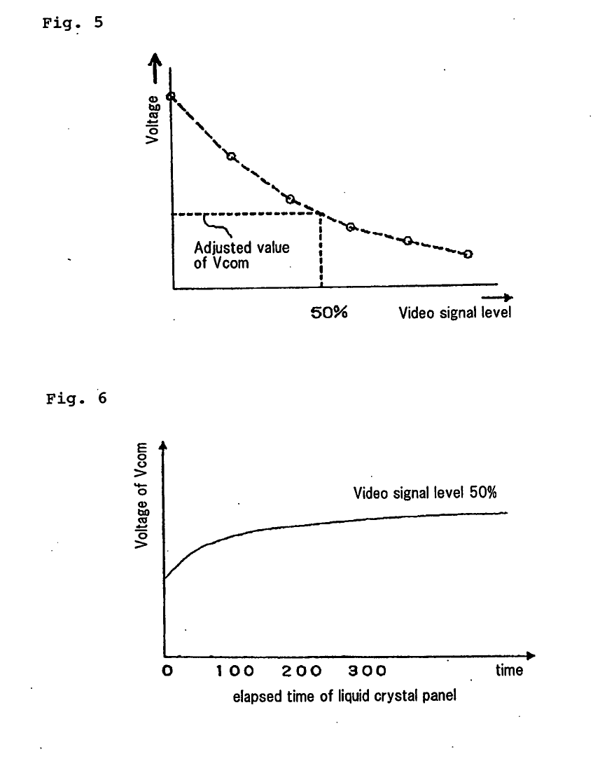

### BEST MODE FOR CARRYING OUT THE INVENTION

### First Exemplary Embodiment

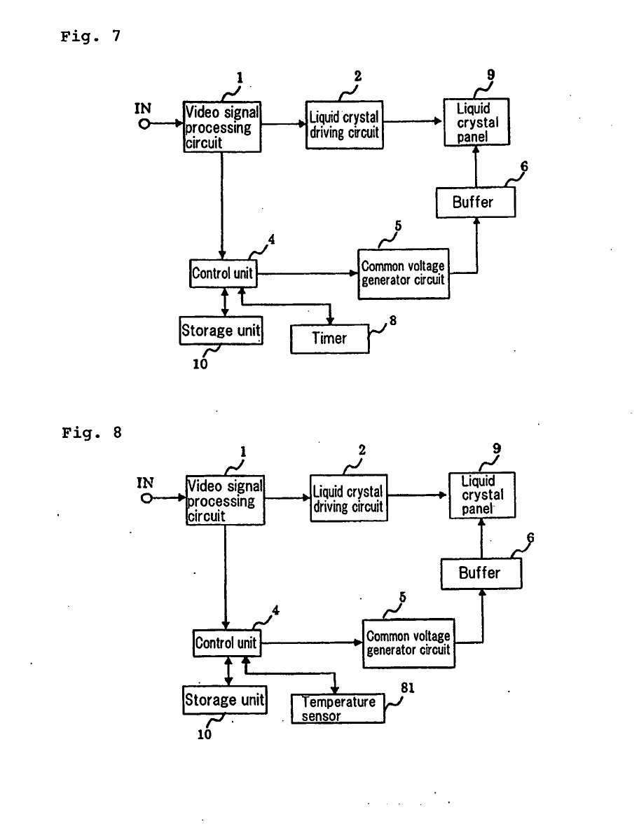

FIG. 7 is a block diagram generally showing the configuration of a liquid crystal display apparatus according to a first exemplary embodiment of the present invention. Referring to FIG. 7, main components of the liquid crystal display apparatus include video signal processing circuit 1, liquid crystal driving circuit 2, control unit 4, common voltage generator circuit 5, buffer 6, timer 8, liquid crystal panel 9, and storage unit 10.

Liquid crystal panel 9 is an existing liquid crystal panel, and the same as the liquid crystal panel shown in FIG. 2, for example, can be used. Video signal processing circuit 1 performs processing for converting a video signal supplied from input terminal IN to a video signal suitable for display on liquid crystal panel 9, for example, scaling processing, frequency conversion processing and the like. Liquid crystal driving circuit 2 performs V-T correction processing, AC drive processing and the like on a video signal supplied from video signal processing circuit 1. Video signal processing circuit 1, liquid crystal driving circuit 2, and liquid crystal panel 9 are basically the same as those shown in FIG. 4. A video signal output from video signal processing circuit 1 is supplied to both liquid crystal driving circuit 2 and control unit 4.

Common voltage generator circuit 5 generates a common voltage (DC voltage) supplied to a common electrode of each liquid crystal cell in liquid crystal panel 9. The common voltage is supplied to the common electrode of each liquid crystal cell in liquid crystal panel 9 through buffer 6. Buffer 6 is a buffer for amplifying a current.

Timer 8 measures a time for which liquid crystal panel 9 has been used up to the present time (accumulated time for which liquid crystal panel 9 has been driven). Specifically, timer 8 comprises a non-volatile memory, and is configured to repeat an operation of counting up once every fixed time during a period in which liquid crystal panel 9 is powered on, store a count value at a time at which liquid crystal panel 9 is powered off in the non-volatile memory, and resume counting up from the count value stored in the non-volatile memory when liquid crystal panel 9 is again powered on. Here, the fixed time (time interval of the count-up) is set to such a time unit that allows used hours of the liquid crystal display apparatus to be accumulated and counted. Specifically, considering that a user performs an on/off operation of the liquid crystal display apparatus at time intervals of several minutes, the time interval of the count-up is preferably set to approximately one minute. This operation of timer 8 is controlled by control unit 4.

Storage unit 10 includes a semiconductor memory or the like, and previously stores characteristic data which represents the relationship between used hours of liquid crystal panel 9 and an optimal value for the common voltage. The characteristic data is, for example, data which indicates the characteristic shown in FIG. 6.

Control unit 4 controls the magnitude of the common voltage generated in common voltage generator circuit 5 at a timing based on a synchronizing signal of a video signal supplied from video signal processing circuit 1. In the common voltage control, control unit 4 determines a time for which liquid crystal panel 9 has been used up to the present time, based on the count value of timer 8, and retrieves an optimal value for the common voltage at the used time (e.g., hours value) with reference to the characteristic data stored in storage unit 10. Then, control unit 4 controls such that the magnitude of the common voltage output from common voltage generator circuit 5 is equal to the retrieved optimal value.

Next, the operation of the liquid crystal display apparatus of this embodiment will be described in a specific manner.

A video signal supplied from input terminal IN is processed in video signal processing circuit 1, and is thereafter supplied to both liquid crystal driving circuit 2 and control unit 4. Liquid crystal driving circuit 2 drives liquid crystal panel 9 based on the video signal supplied from video signal processing circuit 1. While liquid crystal driving circuit 2 is driving liquid crystal panel 9, a common voltage from common voltage generator circuit 5 is supplied to the common electrode of each liquid crystal cell in liquid crystal panel 9. The magnitude of the common voltage output from common voltage generator circuit 5 is controlled by control unit 4 every fixed time, more preferably every several frames to several tens of frames.

According to the liquid crystal display apparatus of this embodiment, when the common voltage is adjusted to an optimal value visually or by utilizing a measuring device, for example, upon shipment of the product, control unit 4 corrects the optimal value for the common voltage for a deviation due to aging changes of liquid crystal panel 9. Thus, the common electrode of each liquid crystal cell is supplied with an optimal common voltage at all times irrespective of the number of hours the liquid crystal panel 9 has been used. Accordingly, it is possible to restrain the polarization of liquid crystal molecules and impurities caused by a deviation of the optimal value for the common voltage, and consequently restrains the occurrence of burn-in.

### Second Exemplary Embodiment

FIG. 8 is a block diagram showing the configuration of a liquid crystal display apparatus according to a second exemplary embodiment of the present invention. The liquid crystal display apparatus of this embodiment is basically the same as that illustrated in FIG. 7 in configuration except that temperature sensor 81 is provided instead of timer 8. In FIG. 8, the same components are designated with the same reference numerals. For avoiding repeated descriptions, in the following, a description on the same operation for the same component is omitted.

Storage unit 10 previously (e.g., in advance) stores characteristic data which represents the relationship between the temperature of liquid crystal panel 9 and an optimal value for a common voltage. Temperature sensor 81 detects the temperature of the liquid crystal display apparatus, and more preferably, the temperature near the liquid crystal panel. The output of temperature sensor 81 is supplied to control unit 4.

Control unit 4 controls the magnitude of the common voltage generated in common voltage generator circuit 5 at a timing based on a synchronizing signal of a video signal supplied from video signal processing circuit 1. In the common voltage control, control unit 4 determines the temperature of liquid crystal panel 9 based on the measurement result of temperature sensor 81, and retrieves an optimal value for the common voltage at this temperature with reference to the characteristic data stored in storage unit 10. Then, control unit 4 controls such that the magnitude of the common voltage output from common voltage generator circuit 5 is equal to the retrieved optimal value.

Next, the operation of the liquid crystal display apparatus of this embodiment will be described in a specific manner.

A video signal supplied from input terminal IN is processed in video signal processing circuit 1, and thereafter is supplied to both liquid crystal driving circuit 2 and control unit 4. Liquid crystal driving circuit 2 drives liquid crystal panel 9 based on the video signal supplied from video signal processing circuit 1. While liquid crystal driving circuit 2 is driving liquid crystal panel 9, the common voltage from common voltage generator circuit 5 is supplied to the common electrode of each liquid crystal cell in liquid crystal panel 9. The magnitude of the common voltage output from common voltage generator circuit 5 is controlled by control unit 4 every fixed time, and more preferably every several frames to several tens of frames.

According to the liquid crystal display apparatus of this exemplary embodiment, when the common voltage is adjusted to an optimal value visually or by utilizing a measuring device, for example, upon shipment of the product, control unit 4 corrects the optimal value for the common voltage for a deviation due to a change in temperature of liquid crystal panel 9. Thus, the common electrode of each liquid crystal cell is supplied with an optimal common voltage at all times irrespective of a change in surrounding temperature. Accordingly, it is possible to restrain the polarization of liquid crystal molecules and impurities caused by a deviation of the optimal value for the common voltage, and consequently restrains the occurrence of burn-in.

### Third Exemplary Embodiment

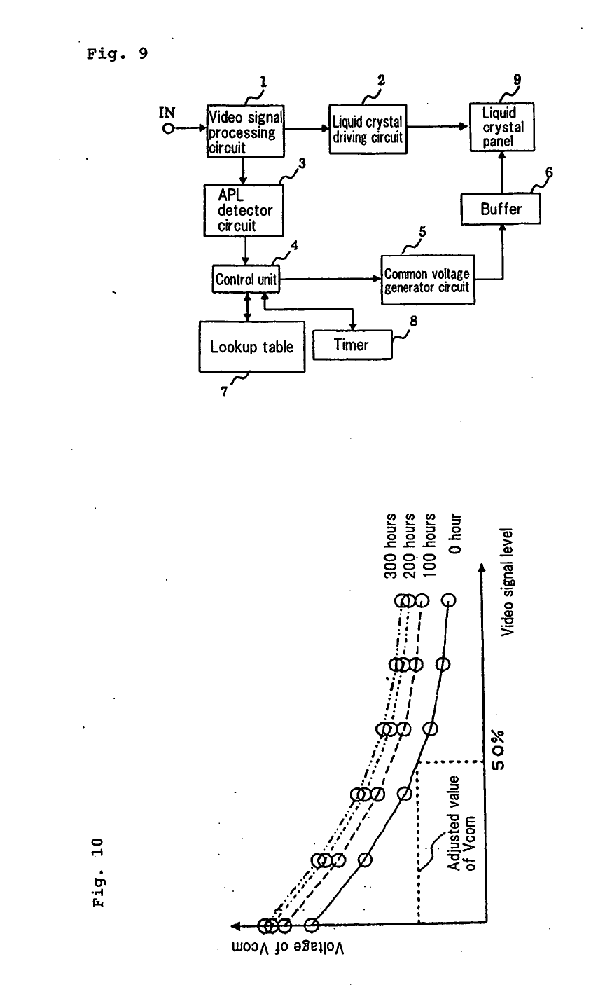

FIG. 9 is a block diagram generally showing the configuration of a liquid crystal display apparatus according to a third exemplary embodiment of the present invention. The liquid crystal display apparatus of this exemplary embodiment includes video signal processing circuit 1, liquid crystal driving circuit 2, APL detector circuit 3, control unit 4, common voltage generator circuit 5, buffer 6, lookup table 7, timer 8, and liquid crystal panel 9. Video signal processing circuit 1, liquid crystal driving circuit 2, common voltage generator circuit 5, timer 8, and liquid crystal panel 9 are basically the same as those shown in FIG. 7. For avoiding repeated descriptions, in the following, a description on the same operation for the same component is omitted.

A video signal output from video signal processing circuit 1 is supplied to both liquid crystal driving circuit 2 and APL detector circuit 3. APL detector circuit 3 detects an average luminance level (average brightness) of the video signal supplied from video signal processing circuit 1 every fixed time.

A specific APL detection will be described giving an example in which a displayed image on liquid crystal panel 9 is composed of a plurality of scanning lines, an input video signal includes a signal of a video area corresponding to each scanning line, the signal of each video area is delimited by a horizontal synchronizing signal, and the overall signals of these video areas are delimited by a vertical synchronizing signal. APL detector circuit 3 extracts a luminance level of a video region for each of a plurality of signals of video areas corresponding to the respective scanning lines, and finds APL for the luminance level of the video area in the overall video signal of one frame. Here, the luminance level of the video area is given in a range from 0% at which the video signal level represents a “black” display, to 100% at which the video signal level represents a “white” display. Such an APL detection operation can be implemented by using a known integrator circuit. An APL value detected by APL detector circuit 3 in units of frames is supplied to control unit 4.

Lookup table 7 stores characteristic data which represents the relationship between a video signal level and an optimal value for the common voltage. A plurality of the characteristic data are prepared in accordance with a number of used hours of the liquid crystal panel. FIG. 10 shows an example of the characteristic data stored in lookup table 7. The characteristic data shown in FIG. 10 was created in consideration of the relationship between the optimal value for the common voltage and the number of hours that the liquid crystal panel has been used, as shown in FIG. 6, and characteristic data is prepared every 100 hours. In FIG. 10, a graph indicated by a solid line shows first characteristic data applied to the liquid crystal panel which has been used for zero hour; a graph indicated by a broken line shows second characteristic data applied to the liquid crystal panel which has been used for 100 hours; a graph indicated by a one-dot chain line shows third characteristic data applied to the liquid crystal panel which has been used for 200 hours; and a graph indicated by a two-dot chain line shows fourth characteristic data applied to the liquid crystal panel which has been used for 300 hours. These characteristic data were created from results actually measured using the actual liquid crystal panel, where a video signal level indicative of “black” display is set at 0%, and a video signal level indicative of “white” display is set to 100%, and an optimal value is found for the common voltage at each of 0%, 20%, 40%, 60%, 80%, and 100%. Data between respective points is interpolated based on data at preceding and subsequent points.

Control unit 4 controls the magnitude of the common voltage generated in common voltage generator circuit 5. In the common voltage control, control unit 4 monitors a count value of timer 8, and retrieves characteristic data corresponding to used hours of liquid crystal panel 9 up to the present time from lookup table 7. Control unit 4 also calculates an average value of APL value (average APL value) supplied from APL detector circuit 3 every several frames, finds an optimal value for the common voltage from the average APL value and retrieved characteristic data, and controls such that the magnitude of the common voltage generated in common voltage generator circuit 5 is equal to this optimal value.

Next, the operation of the liquid crystal display apparatus of this exemplary embodiment will be described in a specific manner.

A video signal supplied from input terminal IN is processed in video signal processing circuit 1, and thereafter is supplied to both liquid crystal driving circuit 2 and APL detector circuit 3. Liquid crystal driving circuit 2 drives liquid crystal panel 9 based on the video signal supplied from video signal processing circuit 1. While liquid crystal driving circuit 2 is driving liquid crystal panel 9, the common voltage generated in common voltage generator circuit 5 is supplied to the common electrode of each liquid crystal cell in liquid crystal panel 9. The magnitude of the common voltage generated in common voltage generator circuit 5 is controlled by control unit 4.

FIG. 11 shows an example of a common voltage control procedure. APL detector circuit 3 detects APL of a video signal supplied from video signal processing circuit 1 in units of frames, and supplies a detected APL value to control unit 4 (step S1).

Next, control unit 4 determines a number of used hours of liquid crystal panel 9 up to the present time based on a count value of timer 8, and retrieves characteristic data corresponding to the used hours from lookup table 7 (step S2). Next, control unit 4 calculates an average value of the APL value (average APL value) supplied from APL detector circuit 3 every several frames to several tens of frames (step S3).

Next, control unit 4 finds an optimal value for the common voltage based on the characteristic data retrieved at step S2 and the average APL value calculated at step S3 (step S4).

Then, control unit 4 controls such that the magnitude of the common voltage supplied from common voltage generator circuit 5 to liquid crystal panel 9 is equal to the found optimal value (step S5).

At step S3 described above, when the count value of timer 8 is within a range of “0” to “99,” control unit 4 determines that display panel 9 has been used for a range of hours between zero or more and less than 100, and retrieves the first characteristic data from lookup table 7. When the count value of timer 8 is within a range of “100” to “199,” control unit 4 determines that display panel 9 has been used for a range of hours between 100 or more and less than 200, and retrieves the second characteristic data from lookup table 7. When the count value of timer 8 is within a range of “200” to “299,” control unit 4 determines that display panel 9 has been used for a range of hours between 200 or more and less than 300, and retrieves the third characteristic data from lookup table 7. When the count value of timer 8 is equal to or more than “300,” control unit 4 determines that display panel 9 has been used for 300 hours or more, and retrieves the fourth characteristic data from lookup table 7.

According to the characteristic diagram shown in FIG. 6, when the liquid crystal panel has been used for 300 hours or more, the optimal value for the common voltage does not deviate so much associated with an aging change, and in this embodiment, the optimal value for the common voltage is substantially constant for the liquid crystal panel which has been used for 300 hours or more, so that the fourth characteristic data is used.

In this regard, if the optimal value for the common voltage still changes over time even after the liquid crystal panel has been used for more than 300 hours, the number of characteristic data must be increased as well in accordance with the change. Also, an optimal value for the common voltage between zero hours, 100 hours, 200 hours, and 300 hours may be calculated through interpolation based on the characteristic data associated with the respective hours.

For example, when the liquid crystal panel has been used for 30 hours, an optimal value for the common voltage at the video signal level of 25% may be calculated through interpolation based on optimal values at video signal levels of 20% and 40% of the characteristic data associated with the liquid crystal panel which has been used for zero hours, and optimal values at video signal levels of 20% and 40% of the characteristic data associated with the liquid crystal panel which has been used for 100 hours. In this event, the optimal value for the common voltage in accordance with the used number of hours can be calculated in units of finer hours.

According to the liquid crystal display apparatus of this exemplary embodiment, control unit 4 controls the magnitude of the common voltage output from common voltage generator circuit 5 in accordance with the APL value of an input video signal. Thus, when a still image with a low APL, for example, is displayed, an optimal common voltage value at the signal level of the still image is supplied from common voltage generator circuit 5 to liquid crystal panel 9. Also, since control unit 4 retrieves the characteristic data from lookup table 7 in accordance with a time (e.g., hours) for which liquid crystal panel 9 has been used, optimal characteristic data can be used even if the optimal value for the common voltage changes associated with aging changes. In this way, since the common voltage is adjusted in accordance with a deviation of the optimal value for the common voltage associated with the APL dependence and aging changes, it is possible to provide a structure which restrains the polarization of liquid crystal molecules and impurity and is less likely to suffer from the burn-in.

In the liquid crystal display apparatus of this embodiment, its configuration and operation can be modified as appropriate. For example, while the characteristic data is switched in accordance with a time for which liquid crystal panel 9 has been used, control unit 4 may calculate a deviation of the optimal value for the common voltage by an approximation equation, instead of the switching of the characteristic data. In this event, as the characteristic data, only the characteristic data associated with used hours “0” is used, by way of example, a common voltage value is calculated from the characteristic data and an average APL value, and an optimal value is calculated by correcting the calculated value based on the deviation derived from the approximation equation.

In the following, a description will be given of the calculation of an optimal value for a common voltage using the approximation equation in a specific manner.

While a deviation of an optimal value for a common voltage associated with aging changes differs from one liquid crystal panel to another (materials of liquid crystal and light distribution film), it can be given by the following equation if a measurement result of an optimal value for a common voltage in an actual liquid crystal panel can be approximately represented by an exponential function:

ΔVcom=A(1−exp(−−Bt)) [Equation 1]

where A and B are constants, t is a time for which the liquid crystal panel has been used. In this event, control unit 4 determines a time for which the liquid crystal panel has been used every fixed time based on the count value of timer 8, and calculates the average of the APL value from APL detector circuit 3. Next, control unit 4 calculates an optimal value for the common voltage from the calculated average APL value and previously given characteristic data. Next, control unit 4 calculates a deviation of the optimal value for the common voltage from the above equation based on the time for which the liquid crystal panel has been used, and corrects the optimal value calculated from the characteristic data based on the deviation. Then, control unit 4 controls the magnitude of the common voltage generated in common voltage generator circuit 5 such that it is equal to the corrected optimal value.

When the optimal value for the common voltage is corrected for a deviation using the approximation equation, the number of lookup tables (the number of characteristic data) can be reduced, thus making it possible to correspondingly reduce the cost of the device.

While the common voltage control by control unit 4 is performed every several frames to several tens of frames, the present invention is not so limited. However, when the common voltage is supplied to the common electrode of the liquid crystal panel, it is difficult to control the common voltage at high speeds because of a large capacitance of the common electrode and a large carrier mobility of a TFT silicon substrate which forms part of a liquid crystal cell. In addition, since the burn-in is caused by continuous projection of the same image for a long time, it is not necessary to follow short-term changes in APL. Considering these facts, the common voltage is preferably controlled every several frames to several tens of frames.

### Fourth Exemplary Embodiment

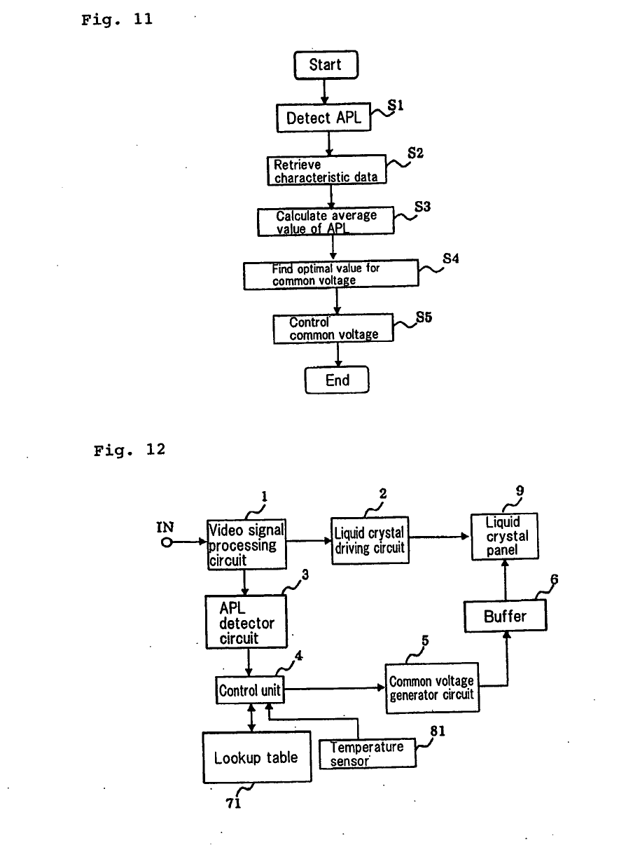

FIG. 12 is a block diagram showing the configuration of a liquid crystal display apparatus according to a fourth exemplary embodiment of the present invention. The liquid crystal display apparatus of this exemplary embodiment is basically the same in configuration as that shown in FIG. 9 except that lookup table 71 and temperature sensor 81 are provided, instead of lookup table 7 and timer 8. In FIG. 12, the same components are designated with the same reference numerals. For avoiding repeated descriptions, in the following, a description on the same operation for the same component is omitted.

As the liquid crystal panel changes in temperature, an optimal value for the common voltage also changes in association with the temperature change. Lookup table 71 stores characteristic data which represents the relationship between a video signal level and the optimal value for the common voltage for each of a plurality of different temperature ranges corresponding to changes in temperature of liquid crystal panel 9. Specifically, an available temperature range of the liquid crystal panel is divided into a plurality of temperature ranges, and the characteristic data representing the relationship between the video signal level and the optimal value for the common voltage for each of the temperature ranges is stored in lookup table 71.

Temperature sensor 81 detects the temperature of the liquid crystal display apparatus, and more preferably, the temperature near the liquid crystal panel. The output of temperature sensor 81 is supplied to control unit 4. Control unit 4 determines the temperature of liquid crystal panel 9 based on the output of temperature sensor 81 every fixed time, calculates the average of APL values from APL detector circuit 3, retrieves characteristic data corresponding to the temperature from lookup table 71, and calculates an optimal value for the common voltage based on the characteristic data and average APL. Then, control unit 4 controls the magnitude of the common voltage generated in common voltage generator circuit 5 such that it is equal to the calculated optimal value.

According to the liquid crystal display apparatus of this embodiment, control unit 4 controls the magnitude of the common voltage output from common voltage generator circuit 5 in accordance with an average video signal level (APL) value. With this control, the optimal value for the common voltage is corrected for a deviation due to the APL dependence. Also, control unit 4 controls the magnitude of the common voltage in accordance with a change in temperature of liquid crystal panel 9. With this control, the optimal value for the common voltage is corrected for a deviation due to a change in temperature of liquid crystal panel 9. In this way, since the common voltage is adjusted in accordance with a deviation of the optimal value for the common voltage associated with the APL dependence and change in temperature, the polarization of liquid crystal molecules and impurities is restrained.

It should be noted that in the liquid crystal display apparatus of this exemplary embodiment, a deviation of the optimal value for the common voltage associated with a change in temperature can be calculated by the aforementioned approximation equation when a measurement result of the optimal value for the common voltage in an actual liquid crystal panel can be approximately represented by an exponential function. Note that t is the temperature of the liquid crystal panel. In this event, as the characteristic data, only the characteristic data associated with used hours “0” is used, by way of example, a common voltage value is calculated from the characteristic data and an average APL value, and an optimal value is calculated by correcting the calculated value based on the deviation derived from the approximation equation.

Specifically, control unit 4 determines the temperature of the liquid crystal panel based on the output of temperature sensor 81 every fixed time, and calculates the average of APL values from APL detector circuit 3. Next, control unit 4 calculates an optimal value for the common voltage from the calculated average APL value and previously given characteristic data. Next, control unit 4 calculates a deviation of the optimal value for the common voltage from the above equation based on the temperature of the liquid crystal panel, and corrects the optimal value calculated from the characteristic data based on the deviation. Then, control unit 4 controls the magnitude of the common voltage generated in common voltage generator circuit 5 such that it is equal to the corrected optimal value.

When the optimal value for the common voltage is corrected for a deviation using the approximation equation, the number of lookup tables (the number of characteristic data) can be reduced, thus making it possible to correspondingly reduce the cost of the device.

Each exemplary embodiment described above is an example of the present invention, and can be modified in configuration and operation as appropriate without departing from the spirit of the present invention. For example, the common voltage control in accordance with aging changes can be used in combination with the common voltage control in accordance with a change in temperature.

Also, while each exemplary embodiment has been described in connection with a single-plate display apparatus, the present invention can also be applied to three-plate liquid crystal display apparatus which includes three liquid crystal panels corresponding to the three primary colors R, G, B. When applied to the three-plate type, a liquid crystal driving circuit, a common voltage generator circuit, and a buffer are provided for each liquid crystal panel. The control unit controls the magnitude of the common voltages output from the respective common voltage generator circuits for each liquid crystal panel. Also, as an APL detector circuit, an APL detector circuit is provided for detecting an average signal level of respective video signals of R, G, B, and the control unit may control the magnitude of the common voltage output from each common voltage generator circuit with reference to the outputs of the respective APL detector circuit.

Also, in the exemplary embodiment which corrects the optimal value for the common voltage for a deviation due to aging changes, it is assumed that the optimal value for the common voltage gradually increases in association with aging changes, but the present invention is not so limited. The present invention can also be applied to a scenario where the optimal value for the common voltage gradually decreases in association with aging changes. In this event, the present invention uses an approximation equation and characteristic data which represents the relationship between the optimal value for such a common voltage and used hours of the liquid crystal display.

Also, the present invention can be generally applied to liquid crystal display apparatuses which employ an AC driven liquid crystal panel comprising a plurality of liquid crystal cells applied with a voltage, the polarity of which is inverted at predetermined period.

With respect to the liquid crystal display apparatus of the first to fourth exemplary embodiments described above, there are the following exemplary first to six aspects which include components for restraining the burn-in due to the polarization of liquid crystal molecules and impurities caused by a change in the optimal value for the common voltage associated with aging changes or changes in surrounding temperature.

A liquid crystal display apparatus according to a first exemplary aspect includes a common voltage generator circuit for supplying a common voltage to a common electrode connected in common to a plurality of liquid crystal cells which form part of the liquid crystal panel, a liquid crystal driving circuit for conducting a control for supplying a voltage in accordance with a video signal input from the outside to the plurality of liquid crystal cells to display an image on the liquid crystal panel, and for inverting the polarity of the voltage supplied to the plurality of liquid crystal cells at a predetermined period, a timer for measuring a time for which the liquid crystal panel has been used, a storage unit for storing characteristic data which represents the relationship between a used time of the liquid crystal panel and an optimal value for the common voltage, and a control unit for determining a time for which the liquid crystal panel has been used up to the present time based on a measurement result by the timer, retrieving an optimal value for the common voltage at the used hours of the liquid crystal display panel with reference to the characteristic data stored in the storage unit, and controlling such that the magnitude of the common voltage output from the common voltage generator circuit is equal to the optimal value.

According to the first exemplary aspect, the control unit retrieves an optimal value for the common voltage for a current used hours value from the characteristic data which represents the relationship between the used hours of the liquid crystal panel and the optimal value for the common voltage, and controls the common voltage such that it is equal to the optimal value. With this control, the optimal value for the common voltage is corrected for a deviation associated with aging changes of the liquid crystal panel.

A liquid crystal display apparatus according to a second exemplary aspect includes a common voltage generator circuit for supplying a common voltage to a common electrode connected in common to a plurality of liquid crystal cells which form part of the liquid crystal panel, a liquid crystal driving circuit for conducting a control for supplying a voltage in accordance with a video signal input from the outside to the plurality of liquid crystal cells to display an image on the liquid crystal panel, and for inverting the polarity of the voltage supplied to the plurality of liquid crystal cells at a predetermined period, an average signal level detector circuit for detecting an average signal level of the video signal, a timer for measuring a time for which the liquid crystal panel has been used, a lookup table for storing a plurality of characteristic data which represent the relationship between a signal level of the video signal and an optimal value for the common voltage, corresponding to a number of used hours of the liquid crystal panel, and a control unit for determining a time for which the liquid crystal panel has been used up to the present time based on a measurement result by the timer, retrieving characteristic data corresponding to the used hours value from the lookup table, calculating an optimal value for the common voltage based on the characteristic data and an average signal level detected in the average signal level detector circuit, and controlling such that the magnitude of the common voltage output from the common voltage generator circuit is equal to the optimal value.

According to the second exemplary aspect, the control unit controls the magnitude of the common voltage output from the common voltage generator circuit in accordance with an average video signal level (APL) value. Thus, when a still image with a low APL, for example, is displayed, an optimal common voltage value at the signal level of the still image is supplied from the common voltage generator circuit to the liquid crystal panel. Also, the control unit controls the magnitude of the common voltage in accordance with a time for which the liquid crystal panel has been used. With this control, the optimal value for the common voltage is corrected for a deviation associated with aging changes of the liquid crystal panel. In this way, since the common voltage is adjusted in accordance with a deviation of the optimal value for the common voltage associated with the APL dependence and aging changes, the polarization of liquid crystal molecules and impurities is restrained.

A liquid crystal display apparatus according to a third exemplary aspect includes a common voltage generator circuit for supplying a common voltage to a common electrode connected in common to a plurality of liquid crystal cells which form part of the liquid crystal panel, a liquid crystal driving circuit for conducting a control for supplying a voltage in accordance with a video signal input from the outside to the plurality of liquid crystal cells to display an image on the liquid crystal panel, and for inverting the polarity of the voltage supplied to the plurality of liquid crystal cells at a predetermined period, an average signal level detector circuit for detecting an average signal level of the video signal, a timer for measuring a time for which the liquid crystal panel has been used, a lookup table for storing characteristic data which represents the relationship between a signal level of the video signal and an optimal value for the common voltage, and a control unit for calculating an optimal value for the common voltage based on the characteristic data stored in the lookup table, and an average signal level detected by the average signal level detector circuit, and controlling such that the magnitude of the common voltage output from the common voltage generator circuit is equal to the optimal value, wherein the control unit determines a time for which the liquid crystal panel has been used up to the present time based on a measurement result by the timer, and corrects the optimal value calculated based on the characteristic data based on the used hours value by an approximation equation which represents a deviation of the optimal value for the common voltage associated with aging changes of the liquid crystal panel.

In the third exemplary aspect, the common voltage is also adjusted in accordance with a deviation of the optimal value for the common voltage associated with the APL dependence and aging changes in a manner similar to the second exemplary aspect, thus restraining the polarization of liquid crystal molecules and impurities.

A liquid crystal display apparatus according to a fourth exemplary aspect includes a common voltage generator circuit for supplying a common voltage to a common electrode connected in common to a plurality of liquid crystal cells which form part of the liquid crystal panel, a liquid crystal driving circuit for conducting a control for supplying a voltage in accordance with a video signal input from the outside to the plurality of liquid crystal cells to display an image on the liquid crystal panel, and for inverting the polarity of the voltage supplied to the plurality of liquid crystal cells at a predetermined period, a temperature sensor for measuring the temperature of the liquid crystal panel, a storage unit for storing characteristic data which represents the relationship between the temperature of the liquid crystal panel and an optimal value for the common voltage, and a control unit for determining the temperature of the liquid crystal panel based on a measurement result by the temperature sensor, retrieving an optimal value for the common voltage for the temperature with reference to the characteristic data stored in the storage unit, and controlling such that the magnitude of the common voltage output from the common voltage generator circuit is equal to the optimal value.

According to the fourth exemplary aspect, the control unit retrieves an optimal value for the common voltage at a current temperature from the characteristic data which represents the relationship between the temperature of the liquid crystal panel and the optimal value for the common voltage, and controls the common voltage such that it is equal to the optimal value. With this control, the optimal value for the common voltage is corrected for a deviation associated with a change in temperature of the liquid crystal panel.

A liquid crystal display apparatus according to a fifth exemplary aspect includes a common voltage generator circuit for supplying a common voltage to a common electrode connected in common to a plurality of liquid crystal cells which form part of the liquid crystal panel, a liquid crystal driving circuit for conducting a control for supplying a voltage in accordance with a video signal input from the outside to the plurality of liquid crystal cells to display an image on the liquid crystal panel, and for inverting the polarity of the voltage supplied to the plurality of liquid crystal cells at a predetermined period, an average signal level detector circuit for detecting an average signal level of the video signal, a temperature sensor for measuring the temperature of the liquid crystal panel, a lookup table for storing characteristic data which represents the relationship between a signal level of the video signal and an optimal value for the common voltage for each of a plurality of different temperature ranges corresponding to a change in temperature of the liquid crystal panel, and a control unit for determining a current temperature of the liquid crystal panel based on a measurement result by the temperature sensor, retrieving the characteristic data corresponding to the temperature from the lookup table, calculating an optimal value for the common voltage based on the characteristic data and an average signal level detected in the average signal level detector circuit, and controlling such that the magnitude of the common voltage output from the common voltage generator circuit is equal to the optimal value.

According to the fifth exemplary aspect, the control unit controls the magnitude of the common voltage output from the common voltage generator circuit in accordance with an average video signal level (APL) value. With this control, the optimal value for the common voltage is corrected for a deviation associated with the APL dependence. Also, the control unit controls the magnitude of the common voltage in accordance with a change in temperature of the liquid crystal panel. In this way, since the common voltage is adjusted in accordance with a deviation of the optimal value for the common voltage associated with the APL dependence and change in temperature, the polarization of liquid crystal molecules and impurities is restrained.

A liquid crystal display apparatus according to a sixth exemplary aspect includes a common voltage generator circuit for supplying a common voltage to a common electrode connected in common to a plurality of liquid crystal cells which form part of the liquid crystal panel, a liquid crystal driving circuit for conducting a control for supplying a voltage in accordance with a video signal input from the outside to the plurality of liquid crystal cells to display an image on the liquid crystal panel, and for inverting the polarity of the voltage supplied to the plurality of liquid crystal cells at a predetermined period, an average signal level detector circuit for detecting an average signal level of the video signal, a timer for measuring a time for which the liquid crystal panel has been used, a lookup table for storing characteristic data which represents the relationship between a signal level of the video signal and an optimal value for the common voltage, and a control unit for calculating an optimal value for the common voltage based on the characteristic data stored in the lookup table, and an average signal level detected by the average signal level detector circuit, and controlling such that the magnitude of the common voltage output from the common voltage generator circuit is equal to the optimal value. The control unit determines a current temperature of the liquid crystal panel based on a measurement result by the temperature sensor, and corrects the optimal value calculated based on the characteristic data based on the temperature by an approximation equation which represents a deviation of the optimal value for the common voltage associated with a change in temperature of the liquid crystal panel.

In the sixth exemplary aspect, the common voltage is also adjusted in accordance with a deviation of the optimal value for the common voltage associated with the APL dependence and change in temperature in a manner similar to the fifth exemplary aspect, thus restraining the polarization of liquid crystal molecules and impurities.

This application is based upon and claims the benefit of priority from Japanese Patent Application No. 2006-325999 filed in Japan Patent Office on Dec. 1, 2006, the contents of which are hereby incorporated by reference.

While exemplary embodiments of the present invention have been described using specific terms, such description is for illustrates purposes only, and it is to be understood that changes and variations may be made without departing from the spirit or scope of the following claims.

1-13. (canceled)

14. A liquid crystal display apparatus including a liquid crystal panel, comprising:
a common voltage generator circuit that supplies a common voltage to a common electrode connected in common to a plurality of liquid crystal cells which form part of said liquid crystal panel;
a liquid crystal driving circuit that conducts a control for supplying a voltage in accordance with a video signal input from outside to said plurality of liquid crystal cells, to display an image on said liquid crystal panel, and that inverts a polarity of the voltage supplied to said plurality of liquid crystal cells at a predetermined period;
a timer that measures a time for which said liquid crystal panel has been used;
a storage unit that stores characteristic data which represents a relationship between a used time of said liquid crystal panel and an optimal value for the common voltage; and
a control unit that determines a time for which said liquid crystal panel has been used up to a present time based on a measurement result by said timer, retrieves an optimal value for the common voltage at the determined used time with reference to the characteristic data stored in said storage unit, and controls such that a magnitude of the common voltage output from said common voltage generator circuit is equal to the optimal value.

15. A liquid crystal display apparatus including a liquid crystal panel, comprising:
a common voltage generator circuit that supplies a common voltage to a common electrode connected in common to a plurality of liquid crystal cells which form part of said liquid crystal panel;
a liquid crystal driving circuit that conducts control for supplying a voltage in accordance with a video signal input from outside to said plurality of liquid crystal cells, to display an image on said liquid crystal panel, and that inverts a polarity of the voltage supplied to said plurality of liquid crystal cells at a predetermined period;
an average signal level detector circuit that detects an average signal level of the video signal;
a timer that measures a time for which said liquid crystal panel has been used;
a lookup table that stores a plurality of characteristic data which represent a relationship between a signal level of the video signal and an optimal value for the common voltage, corresponding to a determined used time of said liquid crystal panel; and
a control unit that determines a time for which said liquid crystal panel has been used up to the present time based on a measurement result by said timer, retrieves characteristic data corresponding to the determined used time from said lookup table, calculates an optimal value for the common voltage based on the characteristic data and an average signal level detected in said average signal level detector circuit, and controls such that a magnitude of the common voltage output from said common voltage generator circuit is equal to the optimal value.

16. A liquid crystal display apparatus including a liquid crystal panel, comprising:
a common voltage generator circuit that supplies a common voltage to a common electrode connected in common to a plurality of liquid crystal cells which form part of said liquid crystal panel;
a liquid crystal driving circuit that conducts a control for supplying a voltage in accordance with a video signal input from outside to said plurality of liquid crystal cells, to display an image on said liquid crystal panel, and that inverts a polarity of the voltage supplied to said plurality of liquid crystal cells at a predetermined period;
an average signal level detector circuit that detects an average signal level of the video signal;
a timer that measures a time for which said liquid crystal panel has been used;
a lookup table that stores characteristic data which represents a relationship between a signal level of the video signal and an optimal value for the common voltage; and
a control unit that calculates an optimal value for the common voltage based on the characteristic data stored in said lookup table, and an average signal level detected by said average signal level detector circuit, and controls such that a magnitude of the common voltage output from said common voltage generator circuit is equal to the optimal value,
wherein said control unit determines a time for which said liquid crystal panel has been used up to the present time based on a measurement result by said timer, and corrects the optimal value calculated based on the characteristic data based on the determined used time by an approximation equation which represents a deviation of the optimal value for the common voltage associated with aging changes of said liquid crystal panel.

17. A liquid crystal display apparatus including a liquid crystal panel, comprising:
a common voltage generator circuit that supplies a common voltage to a common electrode connected in common to a plurality of liquid crystal cells which form part of said liquid crystal panel;
a liquid crystal driving circuit that conducts a control for supplying a voltage in accordance with a video signal input from outside to said plurality of liquid crystal cells, to display an image on said liquid crystal panel, and that inverts a polarity of the voltage supplied to said plurality of liquid crystal cells at a predetermined period;
a temperature sensor that measures a temperature of said liquid crystal panel;
a storage unit that stores characteristic data which represents a relationship between the temperature of said liquid crystal panel and an optimal value for the common voltage; and
a control unit that determines the temperature of said liquid crystal panel based on a measurement result by said temperature sensor, retrieves an optimal value for the common voltage for the temperature with reference to the characteristic data stored in said storage unit, and controls such that a magnitude of the common voltage output from said common voltage generator circuit is equal to the optimal value.

18. A liquid crystal display apparatus including a liquid crystal panel, comprising:
a common voltage generator circuit that supplies a common voltage to a common electrode connected in common to a plurality of liquid crystal cells which form part of said liquid crystal panel;
a liquid crystal driving circuit that conducts a control for supplying a voltage in accordance with a video signal input from outside to said plurality of liquid crystal cells, to display an image on said liquid crystal panel, and that inverts a polarity of the voltage supplied to said plurality of liquid crystal cells at a predetermined period;
an average signal level detector circuit that detects an average signal level of the video signal;
a temperature sensor that measures a temperature of said liquid crystal panel;
a lookup table that stores characteristic data which represents a relationship between a signal level of the video signal and an optimal value for the common voltage for each of a plurality of different temperature ranges corresponding to a change in temperature of said liquid crystal panel;
a control unit that determines a current temperature of said liquid crystal panel based on a measurement result by said temperature sensor, retrieves the characteristic data corresponding to the temperature from said lookup table, calculates an optimal value for the common voltage based on the characteristic data and an average signal level detected in said average signal level detector circuit, and controls such that a magnitude of the common voltage output from said common voltage generator circuit is equal to the optimal value.

19. A liquid crystal display apparatus including a liquid crystal panel, comprising:
a common voltage generator circuit that supplies a common voltage to a common electrode connected in common to a plurality of liquid crystal cells which form part of said liquid crystal panel;
a liquid crystal driving circuit that conducts a control for supplying a voltage in accordance with a video signal input from outside to said plurality of liquid crystal cells to display an image on said liquid crystal panel, and that inverts a polarity of the voltage supplied to said plurality of liquid crystal cells at a predetermined period;
an average signal level detector circuit that detects an average signal level of the video signal;
a timer that measures a time for which said liquid crystal panel has been used;
a lookup table that stores characteristic data which represents a relationship between a signal level of the video signal and an optimal value for the common voltage; and
a control unit that calculates an optimal value for the common voltage based on the characteristic data stored in said lookup table, and an average signal level detected by said average signal level detector circuit, and controls such that the magnitude of the common voltage output from said common voltage generator circuit is equal to the optimal value,
wherein said control unit determines a current temperature of said liquid crystal panel based on a measurement result by said temperature sensor, and corrects the optimal value calculated based on the characteristic data based on the temperature by an approximation equation which represents a deviation of the optimal value for the common voltage associated with a change in temperature of said liquid crystal panel.

20. The liquid crystal display apparatus according to claim 14, wherein:
said video signal is input in units of frames; and
said control unit controls the magnitude of the common voltage output from said common voltage generator circuit every plural frames.

21. The liquid crystal display apparatus according to claim 15, wherein:
said video signal is input in units of frames; and
said control unit controls the magnitude of the common voltage output from said common voltage generator circuit every plural frames.

22. The liquid crystal display apparatus according to claim 16, wherein:
said video signal is input in units of frames; and
said control unit controls the magnitude of the common voltage output from said common voltage generator circuit every plural frames.

23. The liquid crystal display apparatus according to claim 17, wherein:
said video signal is input in units of frames; and
said control unit controls the magnitude of the common voltage output from said common voltage generator circuit every plural frames.

24. The liquid crystal display apparatus according to claim 18, wherein:
said video signal is input in units of frames; and
said control unit controls the magnitude of the common voltage output from said common voltage generator circuit every plural frames.

25. The liquid crystal display apparatus according to claim 19, wherein:
said video signal is input in units of frames; and
said control unit controls the magnitude of the common voltage output from said common voltage generator circuit every plural frames.

26. A method of driving a liquid crystal panel comprised of a plurality of liquid crystal cells, comprising:
supplying a common voltage to a common electrode connected in common to said plurality of liquid crystal cells;
conducting a control for supplying a voltage in accordance with a video signal input from outside to said plurality of liquid crystal cells, to display an image on said liquid crystal panel, and for inverting a polarity of the voltage supplied to said plurality of liquid crystal cells at a predetermined period; and
determining a time for which said liquid crystal panel has been used up to a present time, retrieving an optimal value for the common voltage for the determined used time with reference to characteristic data which represents a relationship between the used time of said liquid crystal panel and an optimal value for the common voltage, and controlling such that a magnitude of the common voltage supplied to said common electrode is equal to the optimal value.

27. A method of driving a liquid crystal panel comprised of a plurality of liquid crystal cells, comprising:
supplying a common voltage to a common electrode connected in common to said plurality of liquid crystal cells;
conducting a control for supplying a voltage in accordance with a video signal input from outside to said plurality of liquid crystal cells, to display an image on said liquid crystal panel, and for inverting a polarity of the voltage supplied to said plurality of liquid crystal cells at a predetermined period;
detecting an average signal level of the video signal;
determining a time for which said liquid crystal panel has been used;
referencing a lookup table for storing a plurality of characteristic data which represent a relationship between a signal level of the video signal and an optimal value for the common voltage, corresponding to a used time of said liquid crystal panel, to retrieve characteristic data corresponding to the determined used time from said lookup table; and
calculating an optimal value for the common voltage based on the retrieved characteristic data and the detected average signal level, and controlling such that a magnitude of the common voltage supplied to said common electrode is equal to the optimal value.

28. A method of driving a liquid crystal panel comprised of a plurality of liquid crystal cells, comprising:
supplying a common voltage to a common electrode connected in common to said plurality of liquid crystal cells;
conducting a control for supplying a voltage in accordance with a video signal input from outside to said plurality of liquid crystal cells, to display an image on said liquid crystal panel, and for inverting a polarity of the voltage supplied to said plurality of liquid crystal cells at a predetermined period;
detecting an average signal level of the video signal, calculating an optimal value based on the average signal level from characteristic data which represents a relationship between a signal level of the video signal and an optimal value for the common voltage, and controlling such that a magnitude of the common voltage supplied to said common electrode is equal to the optimal value; and
determining a time for which said liquid crystal panel has been used up to the present time, and correcting the optimal value calculated from the characteristic data based on the determined used time by an approximation equation which represents a deviation of the optimal value for the common voltage associated with aging changes of said liquid crystal panel.

29. A method of driving a liquid crystal panel comprised of a plurality of liquid crystal cells, comprising:
supplying a common voltage to a common electrode connected in common to said plurality of liquid crystal cells;
conducting a control for supplying a voltage in accordance with a video signal input from outside to said plurality of liquid crystal cells, to display an image on said liquid crystal panel, and for inverting a polarity of the voltage supplied to said plurality of liquid crystal cells at a predetermined period; and
measuring a temperature of said liquid crystal panel, retrieving an optimal value for the common voltage for the temperature with reference to characteristic data which represents a relationship between the temperature of said liquid crystal panel and an optimal value for the common voltage, and controlling such that a magnitude of the common voltage supplied to said common electrode is equal to the optimal value.

30. A method of driving a liquid crystal panel comprised of a plurality of liquid crystal cells, comprising:
supplying a common voltage to a common electrode connected in common to said plurality of liquid crystal cells;
conducting a control for supplying a voltage in accordance with a video signal input from outside to said plurality of liquid crystal cells, to display an image on said liquid crystal panel, and for inverting a polarity of the voltage supplied to said plurality of liquid crystal cells at a predetermined period;
detecting an average signal level of the video signal;
measuring a temperature of said liquid crystal panel;
referencing a lookup table for storing characteristic data which represents a relationship between a signal level of the video signal and an optimal value for the common voltage for each of a plurality of different temperature ranges corresponding to a change in temperature of said liquid crystal panel, to retrieve characteristic data corresponding to the measured temperature of said liquid crystal panel from said lookup table; and
calculating an optimal value for the common voltage based on the retrieved characteristic data and the detected average signal level, and controlling such that a magnitude of the common voltage supplied to said common electrode is equal to the optimal value.

31. A method of driving a liquid crystal panel comprised of a plurality of liquid crystal cells, comprising:
supplying a common voltage to a common electrode connected in common to said plurality of liquid crystal cells;
conducting a control for supplying a voltage in accordance with a video signal input from outside to said plurality of liquid crystal cells, to display an image on said liquid crystal panel, and for inverting a polarity of the voltage supplied to said plurality of liquid crystal cells at a predetermined period;
detecting an average signal level of the video signal, calculating an optimal value based on the average signal level from characteristic data which represents a relationship between a signal level of the video signal and an optimal value for the common voltage, and controlling such that a magnitude of the common voltage supplied to said common electrode is equal to the optimal value; and
measuring a temperature of said liquid crystal panel, and correcting the optimal value calculated from the characteristic data based on the temperature by an approximation equation which represents a deviation of the optimal value for the common voltage associated with a change in temperature of said liquid crystal panel.
